(19) United States
(12) Patent Application Publication
(10) Pub. No.: US 2020/0151525 A1
(43) Pub. Date: May 14, 2020

(54) METHOD FOR MATCHING CHARACTERS AND ATTRIBUTES BETWEEN SYSTEMS TO PERMIT RECORD MATCHING

(71) Applicant: Passport Labs, Inc., Charlotte, NC (US)

(72) Inventor: Michael N.B. Scully, Charlotte, NC (US)

(21) Appl. No.: 16/678,605

(22) Filed: Nov. 8, 2019

Related U.S. Application Data
(60) Provisional application No. 62/758,153, filed on Nov. 9, 2018.

(51) Int. Cl. G06K 9/72; G06K 9/20; G08G 1/017

(52) U.S. Cl. CPC G06K 9/72; G06K 2209/01; G08G 1/0175; G06K 9/2054

(57) ABSTRACT

A method of matching characters and attributes between data processing systems includes: storing an image that includes identifying indicia in a first data processing system; transmitting the image to a second data processing system; receiving the image at the second data processing system; using the second data processing system, performing optical character recognition of the image; using the second data processing system, interpreting an output of the optical character recognition process to produce an interpretation; transmitting the interpretation from the second data processing system to the first data processing system; receiving the interpretation at the first data processing system; using the first data processing system, storing the interpretation in a record in which the interpretation is associated with: the second data processing system; and at least one of a specific user and a specific vehicle.

### BACKGROUND OF THE INVENTION

This invention relates generally to processing of database records, and more particularly to a method for matching records that involve interpretation of media data, such as image, video, or audio recordings, between different systems.

In order to implement cashless tolling, tolling authority data processing systems often include lane-side camera systems that detect and interpret license plates using Optical Character Recognition (“OCR”) techniques, in order to match the license plate numbers to database records where vehicles may be registered.

It is known to use a software application, which may be running on a local or remote computer system, to process image or video records captured from known locations in order to verify the location of a vehicle at a given time. The remote computer system may use the location information for purposes such as calculation and payment of fees, for example road tolls. There is a need for such systems to share license plate information with multiple systems, each of which may be involved in further utilizing this location information, such as for the facilitation of payment.

A single license plate may be interpreted differently in different systems (especially across different agencies, states, or equipment infrastructure).

Consider a license plate “Woo-00Sh!”. A complete interpretation of the license plate involves raw image and/or video data, application of an OCR algorithm, and additional interpretation rules.

One OCR system may recognize the zero (0) as the capital letter “O” or vice versa; another system may confuse the numeral five (5) with the capital letter “S” and/or confuse the exclamation point for the numeral “1”.

Another distinct problem with consistently referencing license plates is consistent interpretation of characters and data formatting, beyond the recognition stage. For example, one system may convert all Os (capital O) to zeros in a database record, which is common among some state license plate protocols. One system may allow for mixed case, while another may convert all characters to upper or lower case for consistency in database records. One system may include hyphens, exclamation points, and/or other punctuation marks or spaces, while another may ignore some or all of them. One system may replace hyphens with spaces.

This inconsistency makes it very difficult for one system to send records to another system that will match on this key field during a matching process or for one system to match a query from another system on this key field, unless there is prior knowledge of the OCR and system interpretation rules.

Another problem is that communication of interpretation rules in themselves has the potential for differing interpretations between parties, because there is some translation that needs to happen in coding the rules as described by one party in the systems of the other party.

Another problem can arise in situations where there is a need or desire to communicate with multiple agencies. In such instances, there is a mutual interest between systems, for differing reasons, in not exchanging any potentially sensitive data unless it is critical for operation. For example, due to privacy concerns, it is not advisable for one system to send personally identifiable information (“PIT”) to another system unless this is required for the associated individual to use that other system. A license plate number could be considered to be PII. Similarly, the other agency does not want to expend resources processing data for a user or vehicle that may never be in the other agency's jurisdiction.

### BRIEF SUMMARY OF THE INVENTION

At least one of these problems is addressed by an automated method of interpreting license plates which does not depend on pre-existing information about system interpretation rules.

According to one aspect of the technology described herein, a method of matching characters and attributes between data processing systems includes: storing an image that includes identifying indicia in a first data processing system; transmitting the image to a second data processing system; receiving the image at the second data processing system; using the second data processing system, performing optical character recognition of the image; using the second data processing system, interpreting an output of the optical character recognition process to produce an interpretation; transmitting the interpretation from the second data processing system to the first data processing system; receiving the interpretation at the first data processing system; using the first data processing system, storing the interpretation in a record in which the interpretation is associated with: the second data processing system; and at least one of a specific user and a specific vehicle.

### BRIEF DESCRIPTION OF THE DRAWINGS

The invention may be best understood by reference to the following description taken in conjunction with the accompanying drawing figures, in which:

FIG. 1 is a schematic diagram of an exemplary data processing system;

FIG. 2 is a schematic view of a vehicle license plate; and

FIG. 3 is a block diagram illustrating steps in a method of determining a license plate interpretation.

### DETAILED DESCRIPTION OF THE INVENTION

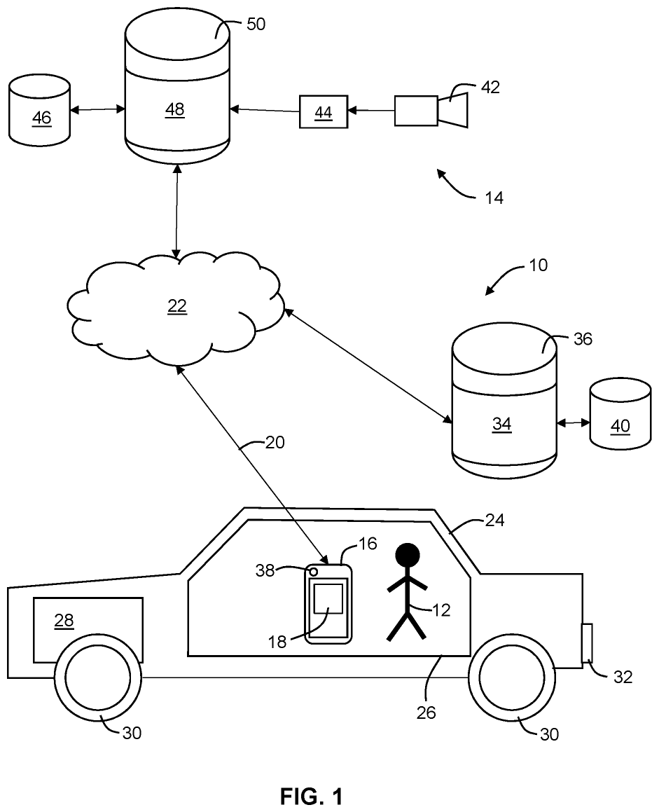

Referring to the drawings wherein identical reference numerals denote the same elements throughout the various views, FIG. 1 illustrates an exemplary data processing system 10 for use by one or more users 12. The data processing system 10 may be referred to generally as a “first data processing system”. In operation, the first data processing system 10 must exchange information and match database records with another data processing system, referred to generally as a “second data processing system” 14.

In the exemplary embodiment described herein, the first data processing system 10 may be a mobile tolling application, and the second data processing system 14 may be a tolling system operated by a government or other toll authority. It will be understood that the principles described herein are applicable to other kinds of data processing systems that must match records that involve interpretation of media data.

The user 12 may interact with the first data processing system 10 using one or more user computing devices 16. The user computing device 16 includes one or more microprocessors operable to execute programmed instructions and supporting components such as an electrical power source (e.g. battery), input/output devices (e.g. keyboard, touchscreen display, microphone, and/or speakers), and one or more transceivers or physical data ports for wired or wireless two-way data transmission. A nonlimiting example of a commercially-available computing device is a personal computer. Optionally, the user computing device 16 may be a mobile computing device. Nonlimiting examples of commercially-available mobile computing devices include laptop computers, tablet computers, “smart watches”, and “smartphones”.

The user computing device 16 may implement at least one location service, defined as a combination of hardware and software operable to determine the geographic location of the mobile user computing device 16. Nonlimiting examples of location services include inertial navigation systems, satellite-based navigation (e.g. GPS, GLONASS), Wi-Fi-based location, and cellular-based location.

In the illustrated example, the user computing device 16 is a conventional smartphone. The user computing device 16 is provisioned with a client software program (also referred to as a “client application” or “client app” 18) containing appropriate programming for carrying out a portion of the method described herein.

The user computing device 16 may be connected by a communications channel 20 such as a Wi-Fi or a cellular data connection to a wide-area network 22 such as the Internet.

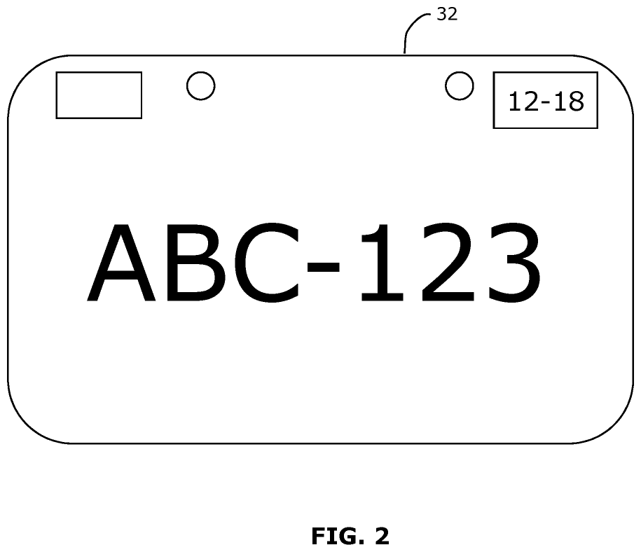

The user computing device 16 may be used in conjunction with a vehicle 24, shown schematically in FIG. 1. The vehicle 24 includes a passenger compartment 26 and a drivetrain of a known type, such as the illustrated prime mover 28 which is coupled to wheels 30 through a transmission (not shown). In operation, the passenger compartment 26 would typically be occupied by the user 12 along with a mobile user computing device 16. The vehicle 24 may be identified with a license plate 32. As shown in FIG. 2, license plate 32 includes identifying indicia such as letters, numbers, and/or special characters.

The data processing system 10 may include a backend application 34 which communicates with the client app 18 through the wide-area network 22. It will be understood that the backend application 34 may be hosted on one or more servers or individual user devices, which are connected to the wide-area network 22. A single server 36 hosting the backend application 34 is depicted schematically in block diagram format.

The steps of the method described herein may be carried out on one or more processors. It will be understood that the method may be carried out entirely using processors contained within the mobile user computing device 16, or entirely using processors contained external to the mobile computing device (e.g. in the server 36), or by some combination of the two.

The first data processing system 10 accepts as input from the user 12 a digital image file of a physical object such as the license plate 32. Nonlimiting examples of digital image file formats include joint photographic experts group (JPEG), tagged image file format (TIF), graphics interchange format (GIF), and exchangeable image file format (Exif). The digital image file may be produced by an imaging device 38, defined herein as a device capable of capturing an image of a physical object and producing a digital representation of the image (i.e., the digital image file). The imaging process may be natively digital or may involve digitizing an analog image. For example, the user computing device 16 may incorporate an imaging device 38 in the form of a conventional digital camera operating in the visible light spectrum.

The first data processing system 10 includes a database 40 in data communication with the backend application 34. The database 40 provides storage for data records relating to the users 12 and/or vehicles 24. For each user 12 and/or vehicle 24, the database 40 stores a record for each external data processing system that the user 12 and/or vehicle 24 has interacted with. For the purposes of the first and second data processing systems 10, 14, it is noted that the term “vehicle” can refer to a specific vehicle and/or a specific configuration of a vehicle. A given vehicle 24 in different use configurations may be treated as distinct vehicles even though the primary vehicle is the same. For example, a vehicle 24 could be treated separately from the same vehicle 24 while towing a trailer. Each record includes at least a reference ID for the external data processing system, a reference ID for the vehicle in the first data processing system, and one or more text fields. The text fields may include information such as: State/Province, license plate characters, and potentially the plate type or other meta-data derived through the interpretation process. The text fields may also include some sort of confidence level. The digital image file would be associated with the record but may be stored, for example, in a separate table. The text field(s) serves as a key for matching records to the second data processing system 14. The procedure by which the text field(s) is/are populated is described in more detail below.

The second data processing system 14 includes at least one imaging device 42, functionally similar to the imaging device 38 described above. In the illustrated example, the imaging device 42 is shown as being a conventional digital camera (still image and/or video) operating in the visible light and/or infrared spectrum.

The second data processing system 14 includes an OCR application 44. The purpose and function of the OCR application 44 is to read the digital image file and to produce text field(s) containing a translation of information contained in the digital image file into machine-readable characters. The text field(s) may include letters, numerals, and/or special characters. OCR applications 44 are commercially available, or a proprietary OCR application may be used. OCR processing may occur contemporaneously with production of the image by the imaging device 42, or on a delayed basis. The raw image may be processed locally to the imaging devices, or may be transmitted over a network (e.g. LAN or WAN) to be processed at a central location. For example, the OCR application 44 may reside on the same server or servers as the backend application described below.

The second data processing system 14 includes a database 46 which provides storage for the text fields.

The second data processing system 14 includes a backend application 48 which may communicate with the imaging device 42 through the wide-area network 22 or other appropriate data network connection. It will be understood that the backend application 48 may be hosted on one or more servers which are connected to the wide-area network 22. A single server 50 hosting the backend application 48 is depicted schematically in block diagram format.

The second data processing system 14 operates by using the imaging device 42 to capture an image of the physical object such as a license plate 32. The OCR application 44 produces an intermediate output file. In producing the output file, the OCR application 44 incorporates an OCR algorithm which attempts to identify attributes and characters. Furthermore, separate from the OCR process, interpretation rules are applied by the second data processing system, for example by the backend application 48 to the intermediate output file in order to generate the text field(s) which is/are then stored in the database 46 or used for other functions. The text field(s) represent the second data processing system's interpretation of the license plate 32. As described below, the text fields serve as a key for matching records to the first data processing system 10.

The system interpretation rules serve to resolve ambiguity and/or enforce uniformity in database records within a given system. As noted above, some letters and numbers may be difficult to accurately resolve using an OCR application 44. Accordingly, a system interpretation rule may convert, replace, or drop characters identified by the OCR application 44. Typically, the first data processing system 10 must operate without knowledge of the system interpretation rules of the second data processing system 14.

The specific hardware and software implementation of the second data processing system 14 are not critical so long as it is capable of receiving an image input and producing corresponding text values.

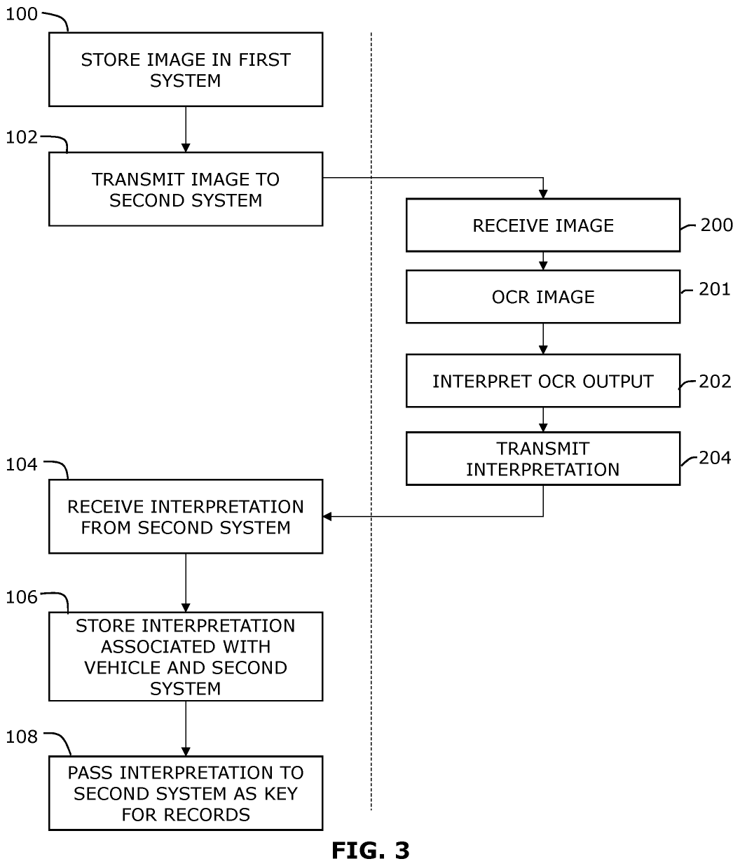

An example of the operation of the first data processing system 10 is described as follows, with reference to FIG. 3.

1. Initially, a user 12 provides a digital image which contains his vehicle's license plate 32 to the first data processing system 10. For example, when the user 12 first registers a vehicle on his account, he produces an image of the rear of the vehicle 24, inclusive of the license plate 32. This image may be produced with the user computing device 16 or with some other device. For example, a conventional digital camera could be used to take a digital photograph which could be uploaded through a web portal.

2. This digital image file (i.e. still image or video) is saved with the vehicle record in the database 40 of the first data processing system 10, block 100.

3. Subsequently, when the vehicle 24 first travels on facilities of the second data processing system 14 (i.e., a toll road), the digital image file is transmitted to the second data processing system 14, block 102. For example, the digital image file may be transmitted over the wide-area network 22 via a web service using a mutually-agreed-upon protocol. Upon receipt of the digital image file (block 200), the second data processing system 14 applies its own OCR algorithm (block 201) and system interpretation rules (block 202) to the digital image file, and transmits the text field as recognized in the second data processing system 14, block 204. This is received by the first data processing system 10, block 104.

4. At block 106, the first data processing system 10 stores the interpretation of the plate 32 for the vehicle 24 in its database, and associates that interpretation with that vehicle 24 and the second data processing system 14.

5. When either the first data processing system 10 sends travel records to the second data processing system 14 for this vehicle 24, or the second data processing system 14 queries the first data processing system 10 for records for this vehicle 24, the first data processing system 10 will know to utilize the license plate interpretation that is used by the second data processing system 14 when in communication with the second data processing system 14, assuring a match. See block 108.

When the same vehicle 24 first travels on facilities associated with another data processing system the process above can be repeated from step 3 to step 5.

The system and method described above have numerous advantages over the prior art. No PII or license plate info is sent to a system until it is required to support a function. No process burden is placed on a system until it is required to support a function. The first data processing system 10 is able to map the interpretation of vehicle plates in its database to the interpretation of those vehicle plates in other systems, one-to-many. Matching is achieved. Billing and enforcement activities will work between systems.

The foregoing has described a system and method for matching characters and attributes between data processing systems to permit record matching. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. A method of matching characters and attributes between data processing systems, comprising:
storing an image that includes identifying indicia in a first data processing system;
transmitting the image to a second data processing system;
receiving the image at the second data processing system;
using the second data processing system, performing optical character recognition of the image;
using the second data processing system, interpreting an output of the optical character recognition process to produce an interpretation;
transmitting the interpretation from the second data processing system to the first data processing system;
receiving the interpretation at the first data processing system;
using the first data processing system, storing the interpretation in a record in which the interpretation is associated with:
the second data processing system; and
at least one of a specific user and a specific vehicle.

2. The method of claim 1 further comprising passing the interpretation from the first data processing system to the second data processing system as a key for records.

3. The method of claim 1 wherein the step of interpreting the output of the optical character recognition process employees at least one rule which converts, replaces or drops at least one character identified in the output of the optical character recognition process.

4. The method of claim 1 wherein the image represents a vehicle license plate.

5. The method of claim 1 wherein, prior to the step of storing an image, the image is captured by an imaging device included in a user computing device.

6. The method of claim 5 wherein the image is uploaded to the first data processing system over a data network.

7. The method of claim 1 wherein the first data processing system is a mobile tolling application.

8. The method of claim 1 wherein the second data processing system is a tolling system operated by a toll authority.

9. The method of claim 1 wherein the image is transmitted from the first data processing system to the second data processing system over a wide area network.

10. The method of claim 1 wherein:
the steps of: storing an image, transmitting the image, receiving the image, performing optical character recognition, interpreting, and transmitting the interpretation, receiving the interpretation at the first data processing system, and storing the interpretation are performed during an initial interaction between a specific user or a specific vehicle of the first data processing system with the second data processing system; and
the remainder of the steps are performed during one or more subsequent interactions between a specific user or a specific vehicle of the first data processing system with the second data processing system.

11. The method of claim 1 wherein:
the image is a digital photograph of a vehicle license plate including identifying indicia; and
the output of the optical character recognition process is a series of machine-readable characters representing the identifying indicia.

12. The method of claim 10 wherein the interpretation comprises the machine-readable characters as modified by at least one interpretation rule.
